(19) United States
(12) Patent Application Publication
(10) Pub. No.: US 2025/0384449 A1
(43) Pub. Date: Dec. 18, 2025

(54) BUSINESS MOBILE DRIVER’S LICENSE (BMDL)

(71) Applicant: Wells Fargo Bank, N.A., San Francisco, CA (US)

(72) Inventor: Jenny Yee Tao, Belmont, CA (US)

(21) Appl. No.: 18/742,559

(22) Filed: Jun. 13, 2024

(51) Int. Cl. G06Q 30/018; G06Q 10/105

(52) U.S. Cl. CPC G06Q 30/018; G06Q 10/105

(57) ABSTRACT

Various systems and methods for managing a business mobile driver's license (BmDL) are described herein. A verifier system for managing digital employment records may be configured to transmit a request for a data element from a user device of a user, the data element included in a business mobile driver's license (BmDL) data structure and receive a response from the user device, the response including: an issuer certificate and a data element that satisfies the request.

### BACKGROUND

Digital wallet systems enable widespread and varied transactions. Digital wallets may store information for use in electronic payments. Retail vendors may offer terminals that read information from the device hosting the digital wallet, resulting in a contactless transaction. Digital wallets provide increased security and speed over conventional transactions with cash or physical credit cards.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating an operating environment, according to an embodiment;

FIG. 2 is a flow diagram illustrating data and control flow for issuing a business mobile driver's license, according to an embodiment;

FIG. 3 is a flow diagram illustrating data and control flow for updating a business mobile driver's license, according to an embodiment;

FIG. 4 is a flow diagram illustrating data and control flow for using a business mobile driver's license, according to an embodiment;

FIG. 5 is a flowchart illustrating a method for managing digital employment records, according to an embodiment; and

FIG. 6 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Systems and methods described herein provide a business mobile driver's license (BmDL). A BmDL may be implemented with digital wallet technology (also referred to as mobile wallet technology). Digital wallets are virtual storage systems that securely store confidential information, such as identification cards, credit cards, event tickets, and the like. Digital wallets may also store payment information and facilitate transactions electronically. They typically store a user's credit/debit card details, bank account information, loyalty cards, and other payment methods.

Digital wallets employ encryption techniques to secure sensitive information, ensuring that confidential data remains protected from unauthorized access. Data may be tokenized. Tokenization is used to replace sensitive data like credit card numbers with unique tokens, reducing the risk of data breaches. Various authentication methods, such as passwords, biometrics (fingerprint, facial recognition), or two-factor authentication (2FA), may be used in conjunction with information in a digital wallet to verify the identity of users. Many digital wallets support Near Field Communication (NFC) technology, allowing users to make contactless payments by simply tapping their smartphones or smartwatches at compatible terminals.

Many digital wallet platforms provide mechanisms to link not only payment devices (e.g., credit cards, debit cards, bank accounts, electronic payment systems, etc.), but also other accounts, such as transit cards, driver's licenses, state identification, boarding passes, tickets, passes, and the like. The present systems and methods described here add a new and useful digital credential for employers. A business mobile driver's license (BmDL) may be used to prove the employment status of a user with the employer. The BmDL is linked to the user's identity in a digital wallet (e.g., a driver's license credential). The BmDL may be used to control physical access to the employer's business. The BmDL may be used to prove employment or membership with the employer. The BmDL may also be used to control access to an employer's online resources (e.g., intranet, employee-only virtual private network (VPN), etc.). These functions and others are described in more detail below.

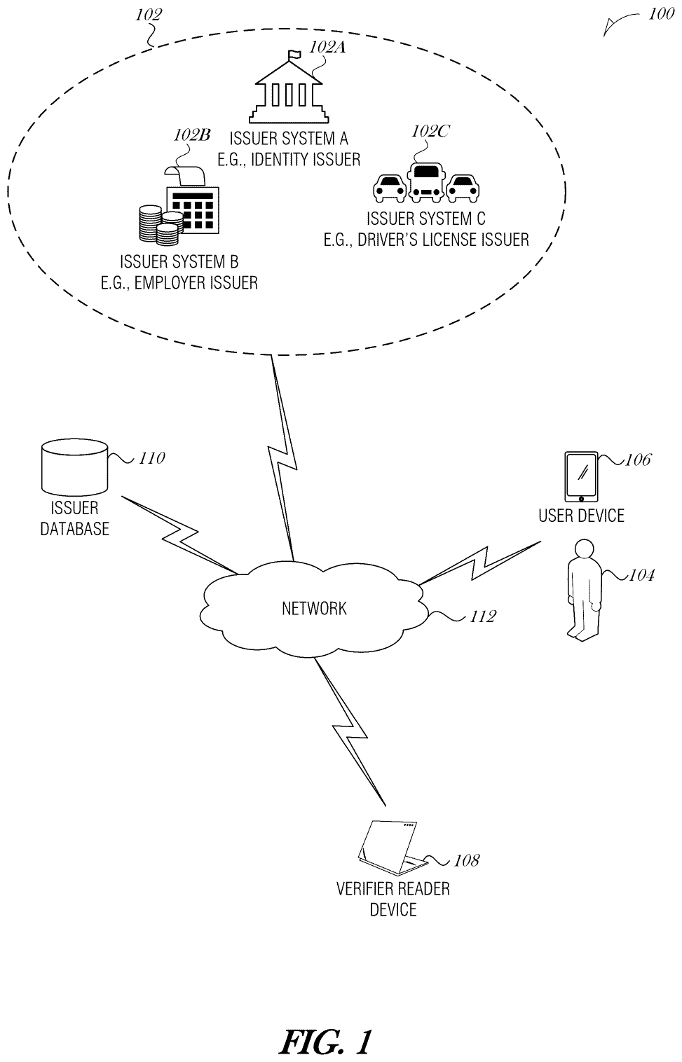

FIG. 1 is a diagram illustrating an operating environment 100, according to an embodiment. Electronic identifications are conducted through three primary entities: a credential issuer, a credential holder, and a credential verifier. In the case of a mobile driver's license (mDL), the credential issuer is typically a government agency (e.g., a motor vehicle service), the credential holder is the person authorized to drive, and the verifier may be a police officer, bartender, voting clerk, or other person who wants to validate the person's identity using the mDL. The credential holder typically provides permission for the verifier to use a reader device (verifier device) to read some or all of the data contained in the mDL, which may include the person's name, age, and an image of the person. The reader device uses public key infrastructure (PKI) to validate the authenticity of the information (being issued by a valid issuer and not altered). The verifier is then able to verify the person's identity.

A business mobile driver's license (BmDL) may be implemented in a number of different ways. In an embodiment, the BmDL is integrated into the mDL data structure (mdoc) as one or more additional data elements stored in the mdoc. For instance, the person's employer name, employer address, and employer contact information may be stored as endorsement fields in a mdoc with respect to one or more driving certifications stored in the mdoc.

In another embodiment, a separate BmDL data structure is used where one or more fields in the BmDL data structure (bmdoc) is used to relate the BmDL to the mDL. The driver's license identification may be stored in the bmdoc, for example. In this manner, when both the mDL and the BmDL are presented to a verifier, via one or more reader devices, the verifier is able to validate that the person is who they attest they are (identification validation) and that the person works where they attest they do (employment validation).

In the environment illustrated in FIG. 1, an issuer system 102 (c.g., identity issuer system 102A, employer issuer system 102B, driver's license issuer system 102C), issues a credential to a user 104. The credential is stored on a user device 106. The credential may be stored in a digital wallet, a digital vault, or some other encryption-based credential storage on the user device 106. The user device 106 may be of any type of mobile device including, but not limited to a smartphone, a laptop computer, a tablet device, a personal digital assistant, a wearable device (e.g., a smartwatch), or the like.

When the user 104 needs to prove their identity, their place of employment, their status of employment, or other aspects with their stored credentials, the user 104 presents the user device 106 to a verifier reader device 108. The verifier reader device 108 may establish a secure connection with the user device 106, authenticate the user device 106, read an issuer certificate, data elements, or other information from the user device 106, and then validate the data received. The verifier reader device 108 may establish a secure connection with an issuer 102, to obtain data from an issuer database 110 and validate the data. The verifier reader device 108 may be a device with specialized application that receives and verifies data from an issuer 102. A verifier reader device 108 may obtain data from a user device 106, for example at a point-of-sale, access point to a building, a parking ramp security gate, etc., and then contact one or more issuers 102 to validate the data.

The issuer database 110 may be associated, managed, or used to store data for one or more issuer systems 102. In an embodiment, each issuer system 102 includes its own issuer database 110. In another embodiment, the issuer database 110 is used to store aggregate business and employment information for multiple business. For instance, the issuer database 110 may be used for several companies that are under the same corporate umbrella.

In a first arrangement, the verifier reader device 108 obtains a PKI token from the user device 106. The PKI token is a digital certificate that was signed by the corresponding issuer. The PKI token is transmitted from the verifier reader device 108 over the secure connection to the issuer 102, which is able to decrypt the digital certificate and verify that it is properly signed by the issuer 102. Using other information from the user device 106, such as the driver's license identification, one or more data elements are retrieved from the issuer 102 by the verifier reader device 108. A person operating the verifier reader device 108 is able to confirm that the information received from the issuer 102 matches the person presenting the user device 106. For instance, a picture of the person may be provided by the issuer 102 and the operating personnel at the verifier reader device 108 is able to confirm the person's identity.

In this type of arrangement, an employer issuer system 102B is able to issue an employment credential that includes employee or employer information, such as an employer name, an employer address, a number of years in employment, a date of starting employment, an end date of employment (e.g., for contract employees), and the like. These data elements may be presented to the operating personnel at the verifier reader device 108 in the same user interface as the mDL information or in a separate user interface. There may be more than one verifier reader device 108, for example, one used to validate the person's identity with an identity issuer system 102A (e.g., to validate a mobile identification credential) and one used to validate the person's employment information with an employer issuer system 102B.

In a second arrangement, the verifier reader device 108 obtains an issuer certificate from the user device 106. Instead of validating the issuer certificate with an issuer 102, the verifier device 108 operates in offline mode and assumes that the issuer certificate is valid based on a comparison with one or more saved certificates. In offline mode, the verifier device 108 obtains data elements of a credential directly from the user device 106.

The issuer 102, user device 106, and verifier reader device 108 may be connected via a network 112. The network 112 may include one or more of local-area networks (LAN), wide-area networks (WAN), wireless networks (e.g., 802.11 or cellular network), the Public Switched Telephone Network (PSTN) network, ad hoc networks, cellular, personal area or peer-to-peer networks (e.g., Bluetooth®, Wi-Fi Direct), or other combinations or permutations of network protocols and network types. The network 112 may include a single local area network (LAN) or wide-area network (WAN), or combinations of LANs or WANs, such as the Internet.

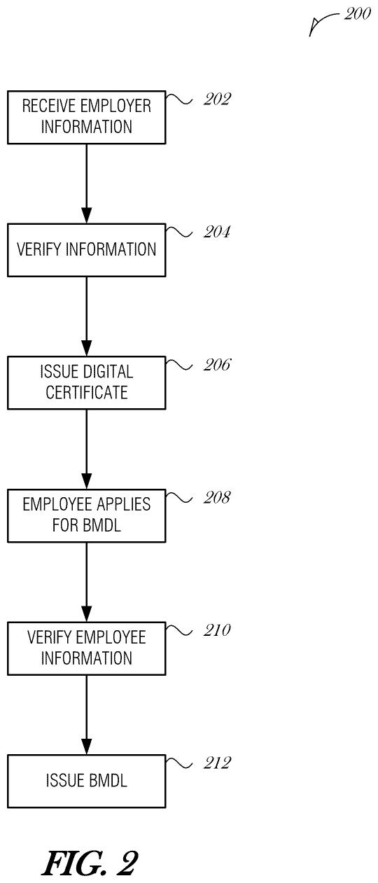

FIG. 2 is a flow diagram illustrating data and control flow 200 for issuing a business mobile driver's license, according to an embodiment. At operation 202, an issuer receives data about an employer. The employer may be a business, non-profit agency, governmental agency, private company, or the like. The employer may employ one or more people that use mobile driver's license technology and may want a digital employment record to prove that the employer employs them.

The issuer may be the employer itself or a third party. For instance, the issuer may be a clearinghouse of business records, such as a Secretary of State's office where business register for incorporation, a business rating office (e.g., Better Business Bureau), a government office (e.g., the Financial Crimes Enforcement Network (FinCEN) is a bureau of the United States Department of the Treasury to monitors business transactions), a tax agency (e.g., a local, state, or federal tax service), or the like.

At operation 202, business information such as the business name, tax identifier, business mailing address, main point of contact, business email, business phone numbers, and the like is received and stored in an issuer database. The business record in the issuer database may have a unique identifier associated with it.

At operation 204, the issuer verifies the information received from the business. Verification may be in various forms, depending on the technological ability of the issuers. In an example, the issuer requires the business to submit copies of verification information, such as articles of incorporation, business tax returns for a prior year, a social security number of the business owner, or other information. The verification information may be submitted in an electronic medium, such as an image of a person's driver's license or an image of a social security card, or a physical medium, such as a physical copy of the business' tax returns.

At operation 206, the issuer issues a digital certificate or provides a digital signature after verifying the business' information. A digital certificate (also known as a public key certificate or identity certificate) is a file that may be used to verify a business record. A digital certificate may include several attributes, such as the business name, a business contact (e.g., URL, email address, phone number, etc.). The digital certificate may also include a public key of the business. The digital certificate is signed by the issuer using the issuer's private key. Verifiers are able to prove the authenticity of a digital certificate by using the issuer's public key. There may be several known trusted issuer public keys. Issuer public keys may have been signed by one or more other authorities in a chain of trust. The root authority may be a reputable certificate authority (CA). A business may desire to have a digital certificate issued by the issuer in order to sign documents, encrypt email, or the like.

A digital signature is a hash of a string value and fixed to a document using a cryptographic key. For instance, the contents of a business record may be hashed using a cryptographic algorithm (e.g., SHA-256, MD5, AES, etc.) and then encrypted using the private key of the issuer. When the recipient receives it, the recipient decrypts the hashed business record using the issuer's public key, performs that same hash function to the unencrypted business record, and then is able to confirm that the information is from the signer and has not been altered by comparing the hashed business record to the unencrypted hashed business record. The business record may be digitally signed by the issuer using a certificate created for the issuer (e.g., a root certificate).

At operation 208, an employee applies for a business mobile driver's license (BmDL). The employee provides information, such as the business name, business email, business address, etc. to uniquely identify the business. The employee also provides information that uniquely identifies the employee and links the employee to a mobile driver's license (mDL), such as a driver's license number, a full name, a date of birth, a social security number, a national identifier, a passport identifier, or the like.

At operation 210, the issuer verifies the employee's identifying information. For verification, the employee may be required to scan their physical driver's license, passport, or other documentation with their smartphone camera. The employee may be required to submit physical documentation to the issuer. The employee may even be required to appear in person at a physical location of the issuer to apply for the BmDL. Different issuers may have different requirements.

At operation 212, the issuer issues a bmdoc for the BmDL, which is signed with the issuer certificate. The BmDL and issuer certificate may be transmitted to an employee's user device, such as a smartphone or other mobile device. The BmDL may be bound to the user device by incorporating a device identifier in the BmDL's bmdoc data elements. For example, in Android-based smartphones, the Android_ID data element is a unique 64-bit number that is generated and stored when the user device is first booted. In Apple-based smartphones, a unique device identifier (UDID), vendor ID, or advertising ID may be used. Optionally, a unique identifier for the device may be generated by the issuer at the time the BmDL is issued and stored in the BmDL.

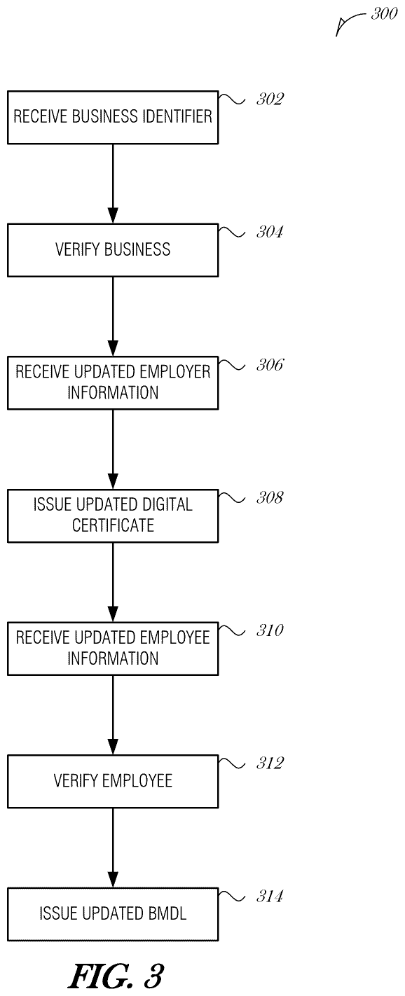

FIG. 3 is a flow diagram illustrating data and control flow 300 for updating a business mobile driver's license, according to an embodiment. In some cases, such as when a business changes its name or location, or when a person changes their state of residence, changes employment, or obtains a new driver's license, the BmDL needs to be updated for accuracy. To update information in a BmDL, either from the business' point of view or from the employee's point of view, the process is substantially the same as when the issuer initially issues the BmDL.

At operation 302, if a business is updating its information, a business identifier, such as the business name, tax identifier, business mailing address, main point of contact, business email, business phone numbers, or another unique identifier associated with it is provided to the issuer.

At operation 304, the issuer verifies that the business is one that exists in the issuer database and that the business can be uniquely identified. The issuer may also verify that the person submitting the business identifier is one who is authorized to update business information at the issuer. This may be performed by using an account that was previously registered at the issuer and is secured with a username and password, for example. Alternatively, the issuer may request a “selfie” of the person submitting the business identifier to perform a biometric face match with an authorized user on file at the issuer.

At operation 306, the issuer receives updated information for the business. This may be a change of address, name change, or the like. The updated information may be required to be supported with documentation, similar to when the business was first registered at the issuer in flow 200.

At operation 308, the issuer issues an updated digital certificate or provides a digital signature after verifying the business' information. At the same time, the issuer may invalidate any other existing digital certificates or digital signatures that were based on the outdated business information.

At operation 310, if an employee needs to change personal information, such as their driver's license that is linked to the business profile, then the employee may provide updated personal information to the issuer in order to receive an updated BmDL. The employee provides information, such as the business name, business email, business address, etc. to uniquely identify the business. The employee also provides information that uniquely identifies the employee and links the employee to a mobile driver's license (mDL), such as a driver's license number, a full name, a date of birth, a social security number, a national identifier, a passport identifier, or the like.

At operation 312, the issuer verifies the employee's identifying information. For verification, the employee may be required to scan their physical driver's license, passport, or other documentation with their smartphone camera. Then, the employee may be required to take a “selfie” picture of themselves to submit with the driver's license, passport, or other identifying documentation. This photo may be used to verify the appearance of the person against the picture in a driver's license, for example. The employee may be required to submit physical documents to the issuer, such as through the post mail or in person. Further, the employee may even be required to appear in person at a physical location of the issuer to apply for the BmDL. Different issuers may have different requirements.

At operation 314, the issuer issues an updated bmdoc for the BmDL, which is signed by the issuer certificate. The updated BmDL and issuer certificate may be transmitted to an employee's user device, such as a smartphone or other mobile device.

If the employee leaves the business (e.g., retires, is terminated, or is a temporary worker that has a contract expire), then the business may contact the issuer to disassociate the business profile from the former employee's mDL. Similarly, the employee may contact the issuer to perform a similar operation but initiated by the employee. The issuer may invalidate the BmDL and delete, mark as invalid, expire, or otherwise disable the BmDL on the former employee's user device for the business-employee relationship. Note that the former employee may have other BmDLs available on their user device for other employment relationships with businesses.

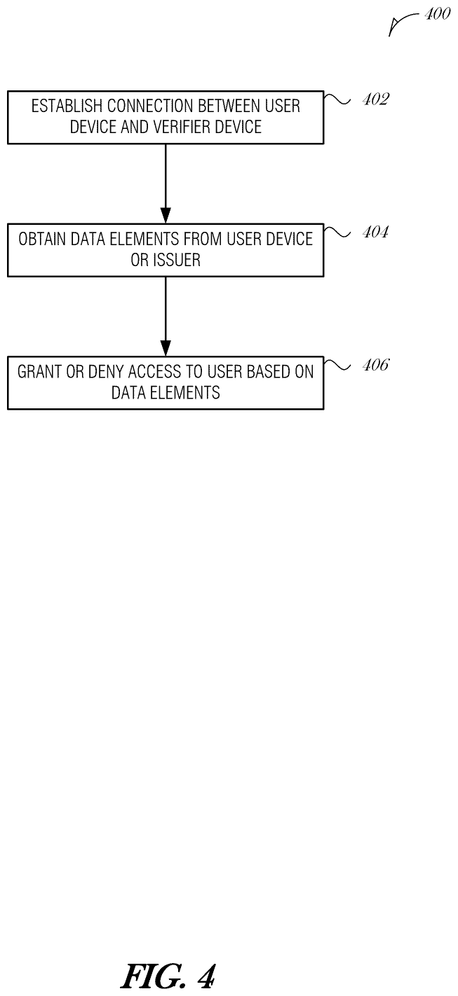

FIG. 4 is a flow diagram illustrating data and control flow 400 for using a business mobile driver's license, according to an embodiment. At operation 402, information is passed from the user device to the verification device. The verification device may include one or more applications (apps) to accept mDL or BmDL data and corresponding issuer certificates. Various implementations may be used depending on whether a wide-area network connection (e.g., cellular) is available.

At operation 404, the verification device uses the information provided by the user device to obtain data elements from an issuer. In the case where there is no wide-area network available for the verification device, the data elements may be obtained from the user device.

Data elements may include the employee's first name (e.g., given name), last name (e.g., family name), picture, date of birth, employment start and end dates, employment status, employment title or job function, business-site permissions, business-site access level, business-site security level, certificate validity information (e.g., issue date and expiration data), hash algorithm (e.g., SHA-1, SHA-2, SHA-256, SHA-512, etc.), or the like.

In a first implementation, the employee presents their user device to a verification device. The employee may tap or place their user device close to the verification device in order to active a near field communication (NFC) connection. The NFC connection may be secured using various encryption protocols. The verification device acts as an NFC terminal and is able to receive a token from the user device. The token is used over the wide-area network to access the issuer database (e.g., using a private, secure web API) and retrieve data directly.

In a second implementation, the user device scans a QR code, which may be posted near the verification device. The QR code is used to authorize controlled data sharing in a privacy-protecting manner.

In a third implementation, the user device scans a QR code, which is used to initiate a direct connection between the user device and the verification device (e.g., using Bluetooth or another short-range wireless protocol).

In a fourth implementation, the employee may interact with an app on the user device to share their BmDL. The verification device is then able to poll nearby devices to determine which devices have consented to share information. Using Bluetooth, for instance, the verification device can establish a secure connection and obtain a token or other information from the user device. This may then be used query the issuer database for the data elements.

If there is no wide-area network access, then the user device may be configured to transmit the issuer certificate and one or more data elements of the bmdoc to the verification device. The verification device may verify the authenticity of the issuer certificate using a list of known trusted issuer certificates, for example, and then assume the authenticity of the data elements that are sent to the verification device.

At operation 406, the employee is either granted access or denied access to the resource based on the interaction between the user device and the verification device. For instance, in an embodiment, the verification device is operated by a person, such as a security officer. The employee taps their user device on the verification device, and then unlocks the user device (e.g., using a fingerprint scan, a facial scan, a passcode, or the like) to allow the user device to interact with the verification device. The BmDL credential is obtained by the verification device (e.g., through direct transfer from the user device or from a query to the issuer database). The person operating the verification device is then able to confirm the identity of the employee and that the employee is associated (employed) with the business.

Access may be time constrained, such that the employee is only allowed access to a building or resource (e.g., computer access) during certain periods. There may be levels or tiers of access. For instance, the employee may not have the property access level to enter a secured area of the business even during regular business hours. Accesses to business resources may be logged. Security or other personnel may be alerted with a business resource is accessed by the employee. Access reports may be generated on a periodic or regular basis. These may be reviewed to determine failed attempts to access resources, unusual activity by people with access, or for other security reasons. Business resources include but are not limited to buildings, rooms, vehicles, labs, computer facilities, or the like. Additionally, the BmDL may be used to access other resources used, reserved, rented, owned, or available to the business' employees, such as a box seats at a sporting event, a conference room in a public venue, discount prices for car rental, flights, or hotel rooms, or other situations where business affiliation provides access, reduced costs, or other benefits for an employee.

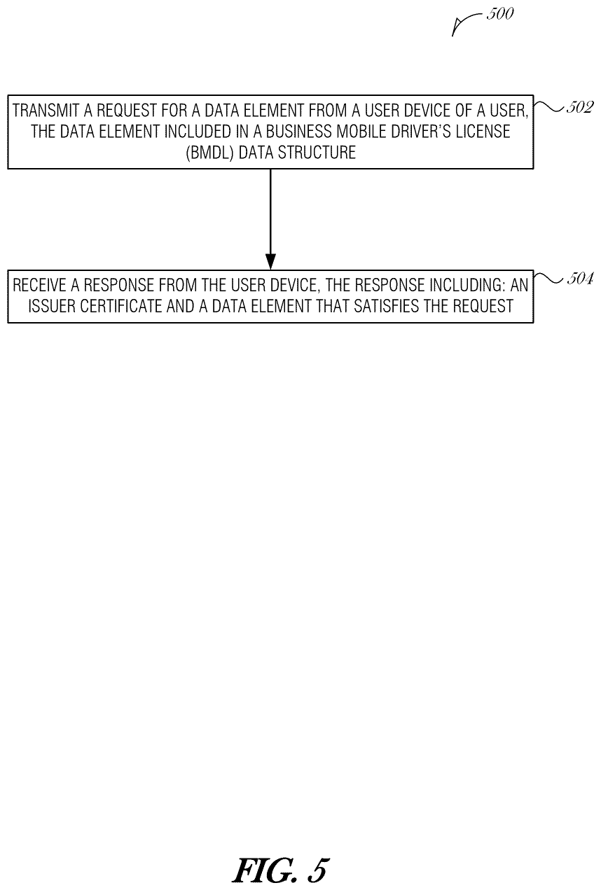

FIG. 5 is a flowchart illustrating a method 500 for managing digital employment records, according to an embodiment. The method 500 may be performed by an electronic system (e.g., issuer system 102, user device 106, verifier reader device 108) or any of the modules, logic, circuits, processors, or components described herein.

At 502, the method 500 includes the operation of transmitting a request for a data element from a user device of a user, the data element included in a business mobile driver's license (BmDL) data structure. In an embodiment, the BmDL is linked to a mobile driver's license of the user.

At 504, the method 500 includes the operation of receiving a response from the user device, the response including: an issuer certificate and a data element that satisfies the request.

In an embodiment, the request specifies an employment verification for a user of the user device, and the data element is an identifier of an employer of the user. In a further embodiment, the identifier of the employer includes an employer name. In another embodiment, the identifier of the employer includes a business name.

In an embodiment, the BmDL was issued by an employer of the user. In a related embodiment, the BmDL is digitally signed by an issuer system.

In an embodiment, the response is used to allow the user access to secured premises. In another embodiment, the response is used to allow the user access to secured business resources. In another embodiment, the request and response are transmitted over a secure communication channel established between the verifier system and the user device.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

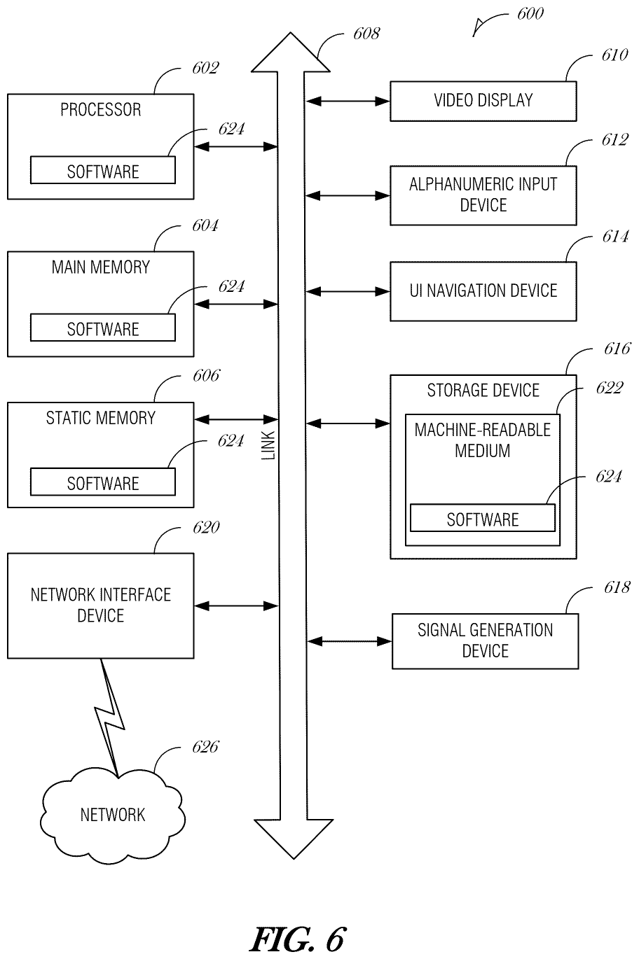

FIG. 6 is a block diagram illustrating a machine in the example form of a computer system 600, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, set-top box, wearable device, personal computer (PC), a tablet PC, a hybrid tablet, a personal digital assistant (PDA), a mobile telephone, cloud server, web server, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 600 includes at least one processor 602 (e.g., a central processing unit (CPU), a graphics processing unit (GPU) or both, processor cores, compute nodes, etc.), a main memory 604 and a static memory 606, which communicate with each other via a link 608 (e.g., bus). The computer system 600 may further include a video display unit 610, an alphanumeric input device 612 (e.g., a keyboard), and a user interface (UI) navigation device 614 (e.g., a mouse). In one embodiment, the video display unit 610, input device 612 and UI navigation device 614 are incorporated into a touch screen display. The computer system 600 may additionally include a storage device 616 (e.g., a drive unit), a signal generation device 618 (e.g., a speaker), a network interface device 620, and one or more sensors (not shown), such as a global positioning system (GPS) sensor, compass, accelerometer, or other sensor.

The storage device 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604, static memory 606, and/or within the processor 602 during execution thereof by the computer system 600, with the main memory 604, static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 is a verifier system for managing digital employment records, the verifier system comprising: a processor subsystem; and memory including instructions, which when executed by the processor subsystem, cause the processor subsystem to: transmit a request for a data element from a user device of a user, the data element included in a business mobile driver's license (BmDL) data structure; and receive a response from the user device, the response including: an issuer certificate and a data element that satisfies the request.

In Example 2, the subject matter of Example 1 includes, wherein the request specifies an employment verification for a user of the user device, and wherein the data element is an identifier of an employer of the user.

In Example 3, the subject matter of Example 2 includes, wherein the identifier of the employer includes an employer name.

In Example 4, the subject matter of Examples 2-3 includes, wherein the identifier of the employer includes a business name.

In Example 5, the subject matter of Examples 1-4 includes, wherein the BmDL is linked to a mobile driver's license of the user.

In Example 6, the subject matter of Examples 1-5 includes, wherein the BmDL was issued by an employer of the user.

In Example 7, the subject matter of Examples 1-6 includes, wherein the BmDL is digitally signed by an issuer system.

In Example 8, the subject matter of Examples 1-7 includes, wherein the response is used to allow the user access to secured premises.

In Example 9, the subject matter of Examples 1-8 includes, wherein the response is used to allow the user access to secured business resources.

In Example 10, the subject matter of Examples 1-9 includes, wherein the request and response are transmitted over a secure communication channel established between the verifier system and the user device.

Example 11 is a method for managing digital employment records, the method performed on an electronic online system, the method comprising: transmitting a request for a data element from a user device of a user, the data element included in a business mobile driver's license (BmDL) data structure; and receiving a response from the user device, the response including: an issuer certificate and a data element that satisfies the request.

In Example 12, the subject matter of Example 11 includes, wherein the request specifies an employment verification for a user of the user device, and wherein the data element is an identifier of an employer of the user.

In Example 13, the subject matter of Example 12 includes, wherein the identifier of the employer includes an employer name.

In Example 14, the subject matter of Examples 12-13 includes, wherein the identifier of the employer includes a business name.

In Example 15, the subject matter of Examples 11-14 includes, wherein the BmDL is linked to a mobile driver's license of the user.

In Example 16, the subject matter of Examples 11-15 includes, wherein the BmDL was issued by an employer of the user.

In Example 17, the subject matter of Examples 11-16 includes, wherein the BmDL is digitally signed by an issuer system.

In Example 18, the subject matter of Examples 11-17 includes, wherein the response is used to allow the user access to secured premises.

In Example 19, the subject matter of Examples 11-18 includes, wherein the response is used to allow the user access to secured business resources.

In Example 20, the subject matter of Examples 11-19 includes, wherein the request and response are transmitted over a secure communication channel established between the verifier system and the user device.

Example 21 is a non-transitory machine-readable medium comprising instructions for managing digital employment records, which when executed by a machine in an online system cause the machine to: transmit a request for a data element from a user device of a user, the data element included in a business mobile driver's license (BmDL) data structure; and receive a response from the user device, the response including: an issuer certificate and a data element that satisfies the request.

In Example 22, the subject matter of Example 21 includes, wherein the request specifies an employment verification for a user of the user device, and wherein the data element is an identifier of an employer of the user.

In Example 23, the subject matter of Example 22 includes, wherein the identifier of the employer includes an employer name.

In Example 24, the subject matter of Examples 22-23 includes, wherein the identifier of the employer includes a business name.

In Example 25, the subject matter of Examples 21-24 includes, wherein the BmDL is linked to a mobile driver's license of the user.

In Example 26, the subject matter of Examples 21-25 includes, wherein the BmDL was issued by an employer of the user.

In Example 27, the subject matter of Examples 21-26 includes, wherein the BmDL is digitally signed by an issuer system.

In Example 28, the subject matter of Examples 21-27 includes, wherein the response is used to allow the user access to secured premises.

In Example 29, the subject matter of Examples 21-28 includes, wherein the response is used to allow the user access to secured business resources.

In Example 30, the subject matter of Examples 21-29 includes, wherein the request and response are transmitted over a secure communication channel established between the verifier system and the user device.

Example 31 is at least one machine-readable medium including instructions that, when executed by processing circuitry, cause the processing circuitry to perform operations to implement of any of Examples 1-30.

Example 32 is an apparatus comprising means to implement of any of Examples 1-30.

Example 33 is a system to implement of any of Examples 1-30.

Example 34 is a method to implement of any of Examples 1-30.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A verifier system for managing digital employment records, the verifier system comprising:
a processor subsystem; and
memory including instructions, which when executed by the processor subsystem, cause the processor subsystem to:
transmit a request for a data element from a user device of a user, the data element included in a business mobile driver's license (BmDL) data structure; and
receive a response from the user device, the response including:
an issuer certificate and a data element that satisfies the request.

2. The verifier system of claim 1, wherein the request specifies an employment verification for a user of the user device, and wherein the data element is an identifier of an employer of the user.

3. The verifier system of claim 2, wherein the identifier of the employer includes an employer name.

4. The verifier system of claim 2, wherein the identifier of the employer includes a business name.

5. The verifier system of claim 1, wherein the BmDL is linked to a mobile driver's license of the user.

6. The verifier system of claim 1, wherein the BmDL was issued by an employer of the user.

7. The verifier system of claim 1, wherein the BmDL is digitally signed by an issuer system.

8. The verifier system of claim 1, wherein the response is used to allow the user access to secured premises.

9. The verifier system of claim 1, wherein the response is used to allow the user access to secured business resources.

10. The verifier system of claim 1, wherein the request and response are transmitted over a secure communication channel established between the verifier system and the user device.

11. A method for managing digital employment records, the method performed on an electronic online system, the method comprising:
transmitting a request for a data element from a user device of a user, the data element included in a business mobile driver's license (BmDL) data structure; and
receiving a response from the user device, the response including: an issuer certificate and a data element that satisfies the request.

12. The method of claim 11, wherein the request specifies an employment verification for a user of the user device, and wherein the data element is an identifier of an employer of the user.

13. The method of claim 12, wherein the identifier of the employer includes an employer name or a business name.

14. The method of claim 11, wherein the BmDL is linked to a mobile driver's license of the user.

15. The method of claim 11, wherein the BmDL was issued and digitally signed by an employer of the user.

16. A non-transitory machine-readable medium comprising instructions for managing digital employment records, which when executed by a machine in an online system cause the machine to:
transmit a request for a data element from a user device of a user, the data element included in a business mobile driver's license (BmDL) data structure; and
receive a response from the user device, the response including: an issuer certificate and a data element that satisfies the request.

17. The non-transitory machine-readable medium of claim 16, wherein the request specifies an employment verification for a user of the user device, and wherein the data element is an identifier of an employer of the user.

18. The non-transitory machine-readable medium of claim 17, wherein the identifier of the employer includes an employer name or a business name.

19. The non-transitory machine-readable medium of claim 16, wherein the BmDL is linked to a mobile driver's license of the user.

20. The non-transitory machine-readable medium of claim 16, wherein the response is used to allow the user access to secured premises.
